(19) United States
(12) Patent Application Publication
(10) Pub. No.: US 2007/0140950 A1
(43) Pub. Date: Jun. 21, 2007

(54) In-situ generation of peroxides in petroleum streams

(76) Inventors: Thomas R. Palmer, Baton Rouge, LA (US); William J. Murphy, Baton Rouge, LA (US); Christ A. Wright, Bordentown, NJ (US)

Correspondence Address: ExxonMobil Research & Engineering Company, P.O. Box 900, 1545 Route 22 East, Annandale, NJ, 08801-0900, US

(21) Appl. No.: 11/303,539

(22) Filed: Dec. 16, 2005

(51) Int. Cl. C01B 15/00

(52) U.S. Cl. 423/582; 423/584

(57) ABSTRACT

This invention relates to a method for generating peroxides in petroleum streams. More particularly, peroxides are generated in-situ by combining the petroleum stream with a high neutralization number (HNN) crude and adding an oxygen-containing stream. HNN crudes contain molecules sufficient for peroxide generation.

### FIELD OF THE INVENTION

This invention relates to a method for generating peroxides in petroleum streams. More particularly, peroxides are generated in-situ by combining the petroleum stream with a high neutralization number (HNN) crude and adding an oxygen-containing stream. HNN crudes contain molecules sufficient for peroxide generation.

### BACKGROUND OF THE INVENTION

Opportunity crudes are crudes that present some difficulties to the refiner and are therefore sold at discount. These crudes may, for example, present corrosion problems because they have high levels of naphthenic acids. Another property of HNN crudes is their elevated levels of large multi-ring naphthene and naphtheno-aromatic molecules. Examples of HNN crudes are Gryphon or Heidrun crude with TAN (total acid number) values of 3.9 and 2.5, respectively. Examples of non-HNN crudes would include Arab Light with a TAN of 0.12 and Olmeca with a TAN of 0.10. However, the supply of such HNN crudes is likely to increase as compared to other low acid crudes. Many strategies have been proposed to deal with acid crudes including corrosion resistant metals, corrosion inhibitors and process modifications.

Almost all crudes contain contaminants that must be removed. The conventional method for removing sulfur (HDS) and nitrogen (HDN) contaminants from lubricant feedstocks in large integrated refineries involves hydrotreating over hydrotreating catalysts. Although hydrotreaters involve an up-front capital expense, hydrotreaters are effective and operational considerations make them a viable economic alternative for removing sulfur and nitrogen contaminants.

Some refineries use solvent refining techniques to produce lubricant basestocks. Solvent refining techniques use solvents to separate a more paraffinic raffinate from a more aromatic extract. As many sulfur and nitrogen contaminants occur in aromatic compounds, they tend to accumulate in the aromatic extract. Solvent refining techniques alone are limited in the economic production of basestocks having a VI greater than about 105. The ever increasing performance standards for modern automobile engines are resulting in demands for basestocks with higher VI. Thus many original equipment manufacturers specify that lubricating oils meet Group II requirements (90+% saturates, <0.03% sulfur, 80-119 VI) and the trend is to even higher basestock qualities of Group III (90+ saturates, <0.03% sulfur and 120+ VI). In order to meet Group II standards, solvent extraction has been combined with hydrotreating wherein hydrotreating is used to boost the VI of the raffinate.

Another approach to remove sulfur and nitrogen contaminants is the use of chemical oxidants to convert the sulfur and nitrogen compounds to more polar oxidized species such as sulfoxides, sulfones, nitro compounds, nitroso compounds or amine oxides. The most commonly used oxidant is peroxide based, including for example, inorganic and organic peroxy acids and hydrogen peroxide. The chemical oxidant may be combined with a catalyst to further reduce nitrogen and sulfur contaminants.

Peroxides have also been added to fuels for producing oxygenated components which components impart beneficial properties to the fuels. Peroxides are, however, relatively expensive and may raise operational concerns.

It would be desirable to have an alternative to added chemical oxidants to generate peroxides in petroleum streams and to have an outlet for crudes that present corrosion problems.

### SUMMARY OF THE INVENTION

One embodiment of the invention relates to an in-situ method for generating peroxides in crudes or distillates which comprises: (a) mixing the crude or distillate with a high neutralization number crude having a total acid number (TAN) greater than 1.0 to produce a mixture of crude or distillate and high neutralization crude, and (b) adding an oxygen-containing gas to the mixture from step (a) for a time sufficient to generate peroxides in a concentration of at least about 1 wt. %, based on mixture.

### BRIEF DESCRIPTION OF THE DRAWINGS

FIG. 1 shows the FTIR subtraction spectra of four sequential samples undergoing oxidation across a wavelength ranging from 600 to 2000 cm⁻¹.

FIG. 2 shows FTIR subtraction spectra of four sequential samples undergoing oxidation reactions generally associated with the region where oxidation products are measured.

### DETAILED DESCRIPTION OF THE INVENTION

Crude oils and distillate fractions that are considered corrosive generally contain organic acids. The organic acids most commonly associated with acidic properties are naphthenic acids. The acidity of a crude or distillate is normally measured as the Total Acid Number or TAN. The TAN is measured by standard ASTM methods such as D-664 and is expressed as the number of milligrams of KOH need to neutralize one gram of oil. Crudes and distillates with TAN values below 0.5 are considered non-corrosive, those with TAN values between 0.5 and 1.0 are considered moderately corrosive and those with TAN values above 1.0 are considered corrosive. These corrosive crudes are known as High Neutralization Number crudes or “HNN” crudes.

Suitable feeds for mixing with HNN crudes include crudes having a TAN less than 1.0, reduced crudes, raffinates, hydrotreated oils, hydrocrackates, atmospheric gas oils, vacuum gas oils, coker gas oils, atmospheric and vacuum resids, deasphalted oils, slack waxes and Fischer-Tropsch wax. Such feeds may be derived from distillation towers (atmospheric and vacuum), hydrotreaters and solvent extraction units, and may have wax contents of up to 50% or more.

HNN crudes and distillates derived therefrom are not typically used for the production of lubricant basestocks because of their inherent instability to oxidation. These crudes contain multi-ring naphthenes and naphtheno-aromatic compounds that are easily oxidized because they have exposed tertiary hydrogens that are readily susceptible to oxidation. It is this oxidation instability which has been used to advantage in the instant process.

In the present process, the multi-ring naphthenes and naphtheno-aromatic compounds in HNN crudes and distillates are oxidized by exposing these compounds to an oxidizing medium to form in-situ generated hydroperoxides. An example of such a reaction is as follows:

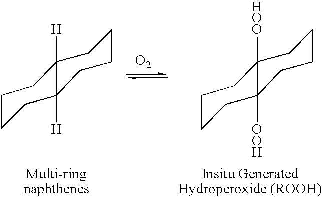

Naphthenes are cycloparaffins having one or more cyclic rings. The rings may have 5 or more carbon atoms and may be substituted with sub stituents such as alkyl groups. Examples of one ring naphthenes include cyclopentane, cyclohexane, cyclooctane, methyl cyclohexane, ethyl cyclohexane, and the like. Naphthenes may also be polycyclic, i.e., containing multiple rings. Heavier petroleum fractions commonly include polycyclic naphthenes containing 2, 3, 4, 5 or more cyclic rings which may be fused. The cyclic rings may contain 5 or more carbon atoms and may bear substituents such as alkyl. The polycyclic naphthenes may also be bridged. Naphtheno-aromatics are fused polycyclic hydrocarbons containing both aromatic and naphthene ring systems. The fused ring systems may contain 2 or more rings and the rings may contain 5 or more carbon atoms. Preferred naphthenes and naphtheno-aromatics contain 2 or more rings which may be substituted with alkyl. Examples include decalin, adamantane, cholestane, tetralin, norborane, 3-methyl-1,2-cyclopentenophenanthrene, 1,2,3,4-tetrahydrophenanthrene, indane, perhydroanthracene, perhydrofluorene and perhydroterphenyl.

The amount of HNN crudes that are mixed with other crudes, distillates or mixtures thereof range from 10 to 100 wt. %, based on total mixture of HNN crude and other crude or distillate, preferably 30 to 100 wt. %. The mixing of HNN crudes with other petroleum crudes and distillates occurs at temperatures greater than about 50° C.

The oxidizing medium is preferably an oxygen-containing gas, more preferably oxygen, most preferably air. Ozone may also be used as an oxidizing medium. The oxidizing medium may be mixed with other non-oxidizing gases or may be mixed with inert solvent. In order to form in-situ hydroperoxides, an oxygen-containing gas is added to the mixture by any conventional means for mixing gases and liquids. Oxygen-containing gas is added for a time sufficient to form hydroperoxides.

The oxygen-containing gas may be added by conventional means such as frits, spargers, bubbles and the like, or may be added under pressure to a vessel containing the HNN mixture and allowed to diffuse into HNN mixture. The conditions for adding oxygen-containing gas include temperatures from ambient to 700° C., pressures from atmospheric to 34576 kPa (5000 psig), and treat gas rates up to 534 m³/m³ (3000 scf/B). The in-situ generated peroxides may then be reacted in the same way as conventionally added peroxides such as hydrogen peroxide. For example, in-situ generated peroxides involving polar species may the used to separate or destroy the polar species. U.S. Pat. No. 5,310,479 discloses that the sulfur content of whole crudes may be reduced by treating the crude with hydrogen peroxide and formic acid followed by water washing to remove water soluble oxidized sulfur compounds. In-situ generated peroxides have a cost advantage since no expensive peroxides need be purchased. Moreover, the need to handle peroxides external to the reaction mixture is avoided.

This invention is further illustrated by the following example.

### EXAMPLE

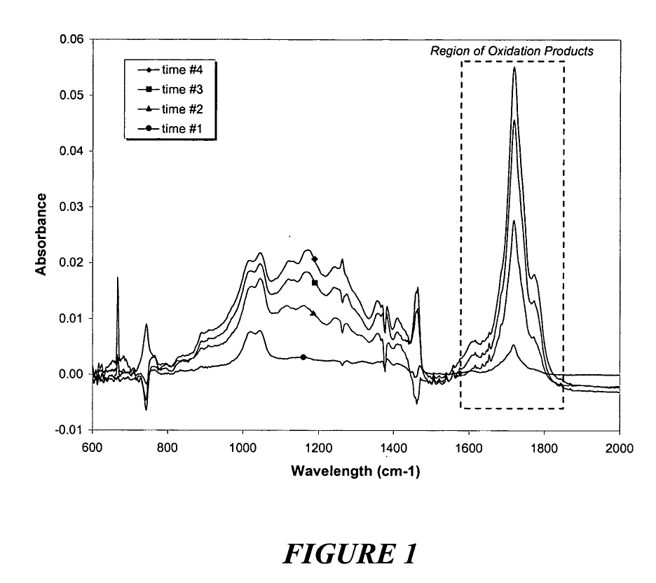

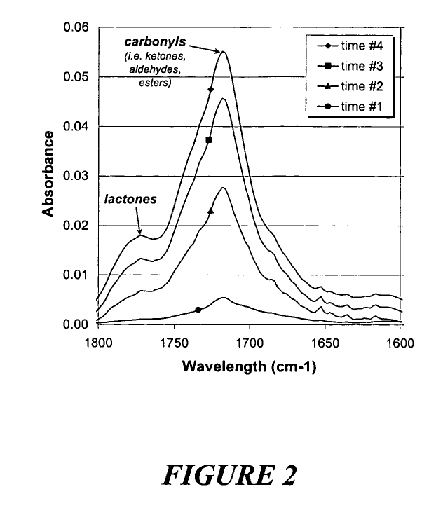

Experiments were conducted using a dewaxed HNN distillate as a test fluid and heated to 150° C. in the presence of air bubbling through the fluid. The oxidation products were measured by Fourier Transform Inferred Spectroscopy (FTIR) to determine the existence of oxidation products. Additionally a sample was heated in the presence of a nitrogen gas instead of air to determine the effect of any thermal degradation of the fluid under these test conditions. This sample was also measured by FTIR and used as a baseline reading. A subtraction spectra was generated at four different times during the oxidation experiments using the FTIR readings minus the baseline reading. The results are given in FIGS. 1 and 2, where FIG. 1 shows the FTIR subtraction spectra of four sequential samples undergoing oxidation across a wavelength ranging from 600 to 2000 cm⁻¹. FIG. 2 shows FTIR subtraction spectra of four sequential samples undergoing oxidation reactions generally associated with the region where oxidation products are measured. The Figure shows a close-up of products FTIR subtraction spectra for the region of interest to determine oxidation products of four sequential samples undergoing oxidation reactions.

When examining the spectra generated from these samples, it is evident that there was an increase in the amount of oxidation products generated as the oxidation reaction proceeded, shown by the increase in the area under the peaks in the 1600-1800 cm⁻¹ region. Specifically, there are noticeable peaks present at 1773 representing carbonyls such as ketones, aldehydes, and esters, along with a peak at 1718 cm⁻¹ representing the presence of lactone carbonyls. This data provides proof that oxidation reactions occurred during the experiments. In order for the oxidation pathways necessary for these reactions to occur, an intermediate step must have existed in which peroxides or hydroperoxides were generated. An example reaction is provided below showing the pathway from a hydrocarbon to a ketone carbonyl.

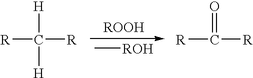

1. An in-situ process for generating peroxides in crudes, distillates or mixtures thereof which comprises: (a) mixing the crude or distillate with a high neutralization number crude having a total acid number (TAN) greater than 1.0 to produce a mixture of crude or distillate and high neutralization crude, and (b) adding an oxygen-containing gas to the mixture from step (a) for a time sufficient to generate peroxides in a concentration of at least about 1 wt. %, based on mixture.

2. The process of claim 1 wherein the amount of HNN crudes that are mixed with other crudes, distillates or mixtures thereof range from 10 to 100 wt. %, based on total mixture of HNN crude and other crude or distillate.

3. The process of claim 1 wherein the oxygen-containing gas is air.

4. The process of claim 1 wherein the conditions for adding oxygen-containing gas include temperatures from ambient to 700° C., pressures from atmospheric to 34576 kPa (5000 psig), and treat gas rates up to 534 m³/m³ (3000 scf/B).

5. The process of claim 1 wherein the crudes, distillates or mixtures thereof include crudes having a TAN less than 1.0, reduced crudes, raffinates, hydrotreated oils, hydrocrackates, atmospheric gas oils, vacuum gas oils, coker gas oils, atmospheric and vacuum resids, deasphalted oils, slack waxes and Fischer-Tropsch wax.

6. The process of claim 1 wherein the oxygen-containing gas is added to mixture of crude or distillate and high neutralization crude at temperatures from ambient to 700° C., pressures from atmospheric to 34576 kPa (5000 psig), and treat gas rates up to 534 m³/m³ (3000 scf/B).
